(19) United States
(12) Patent Application Publication
(10) Pub. No.: US 2017/0215033 A1
(43) Pub. Date: Jul. 27, 2017

(54) Wearable Apparatus for Personal Security

(71) Applicant: F.R.I.E.N.D. Security Systems LLC, Woburn, MA (US)

(72) Inventors: Lauren Beth Piraino, Woburn, MA (US); Anthony John Piraino, Danvers, MA (US); Brian Henderson Childs, Clearwater, FL (US)

(21) Appl. No.: 15/417,176

(22) Filed: Jan. 26, 2017

Related U.S. Application Data
(60) Provisional application No. 62/287,258, filed on Jan. 26, 2016.

(51) Int. Cl. H04W 4/02; H04B 1/3827

(52) U.S. Cl. CPC H04W 4/02; H04B 1/385; H04W 4/22

(57) ABSTRACT

A wearable apparatus for providing personal safety contains an enclosure, a microprocessor, a global positioning system (GPS) module, a push button, and a wireless communication device. Based on the enclosure, the apparatus can be worn around the neck or on the wrist. Since the GPS module, the microprocessor, and the wireless communication device are housed within the enclosure, the apparatus can also be used as a handheld device. During an emergency, the user utilizes the push button to transmit an emergency alert via the wireless communication device. The emergency alert will contain location coordinates that are obtained through the GPS module. The emergency alert is sent to a designated recipient so that the user of the apparatus can receive assistance within a short time.

The current application claims a priority to the U.S. Provisional Patent application Ser. No. 62/287,258 filed on Jan. 26, 2016.

### FIELD OF THE INVENTION

The present invention relates generally to personal security devices. More specifically, the present invention introduces a wearable personal security device. Per user preference, the present invention can be worn as a necklace pendant or a bracelet.

### BACKGROUND OF THE INVENTION

Security systems are integrated into homes, business offices, stores, army bases, banks, and variety of other buildings. Security systems are meant to alert those within the building of an emergency or situation occurring within a specific part of the building. This however is not the most efficient way to notify individuals within a building or area.

In addition, security systems integrated within buildings tend to be limited. As an example, most of these systems are activated only when a person enters a restricted area, a fire erupts, or a similar emergency is detected. Moreover, current security systems are limited due to the amount of time and distance the security system may monitor. The inability to give an exact location is another major disadvantage with most security systems and personal safety equipment. The failure to recognize the exact location has resulted in many individuals being left in unfavorable circumstances in the recent past. Therefore, the need for a method to retrieve the exact location from a user is clear.

Most personal safety systems require the user to go through a lengthy process prior to notifying authorities regarding a situation. As an example, the user may be required to contact authorities through a software application installed in their mobile phone. Executing such a process during an emergency may not always be possible. Therefore, a method to directly communicate with the authorities is needed.

The objective of the present invention is to address the issues. The present invention introduces a wearable apparatus that can be used in emergency situations. The present invention allows the user to immediately notify authorities in times of an emergency. In doing so, the present invention transmits an exact location of the user so that the emergency responders can attend to the individual within a short time. The effective design allows the user to utilize the present invention to be worn in multiple configurations. By utilizing the present invention, the user is guaranteed to receive assistance regardless of the location or the type of emergency.

### BRIEF DESCRIPTION OF THE DRAWINGS

FIG. 1 is a perspective view of present invention, wherein the present invention is worn as a necklace pendant.

FIG. 2 is a front view of the present invention. wherein the present invention is worn as a necklace pendant.

FIG. 3 is a side view of the present invention, wherein the present invention is worn as a necklace pendant.

FIG. 4 is another perspective view of the present invention, wherein the present invention is worn on the wrist.

FIG. 5 is another front view of the present invention, wherein the present invention is worn on the wrist.

FIG. 6 is a top view of the present invention, wherein the present invention is worn on the wrist.

FIG. 7 is a perspective view of an alternative embodiment of the present invention.

FIG. 8 is a front view of the alternative embodiment of the present invention.

FIG. 9 is a side view of the alternative embodiment of the present invention.

FIG. 10 is a system diagram of the present invention.

### DETAIL DESCRIPTIONS OF THE INVENTION

All illustrations of the drawings are for the purpose of describing selected versions of the present invention and are not intended to limit the scope of the present invention.

The present invention is a wearable personal safety device that can be used to notify authorities in case of an emergency. In doing so, the present invention transfers user location data to designated personnel so that the user can receive assistance in an emergency. More specifically, the efficiency of the present invention minimizes the response time of the emergency responders.

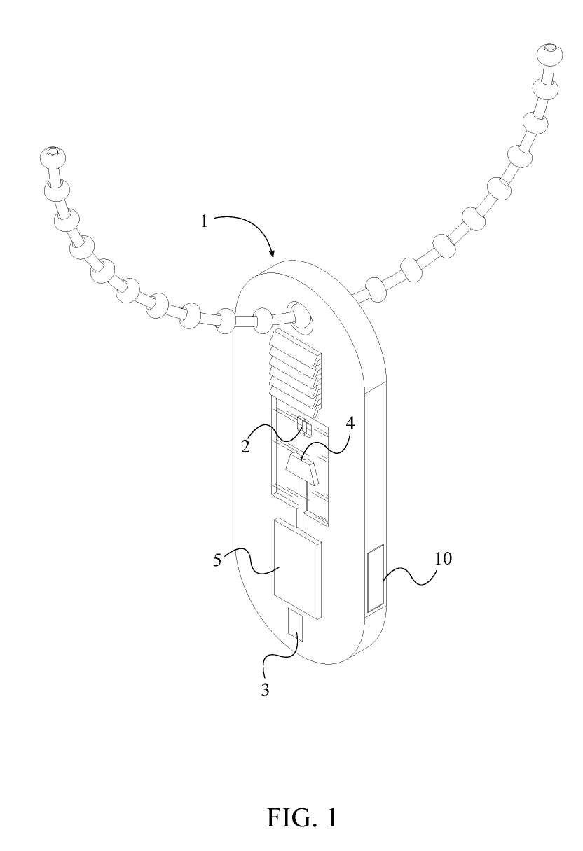

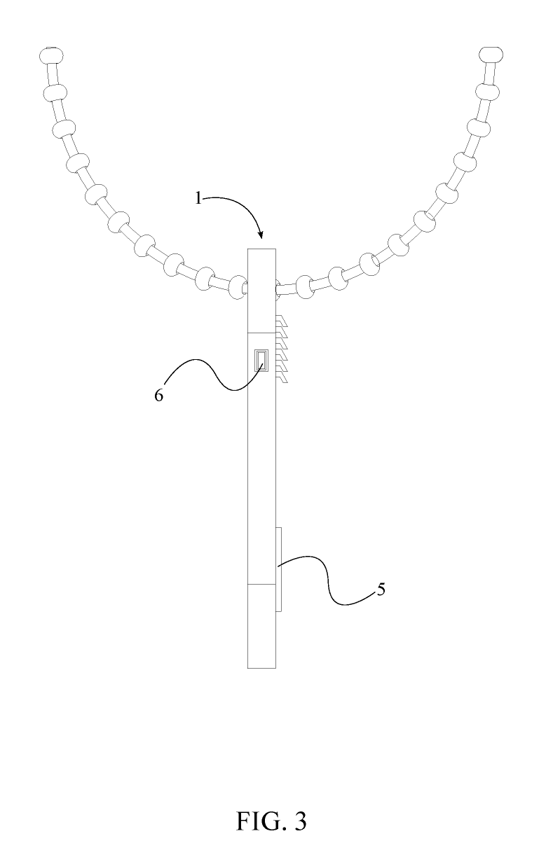

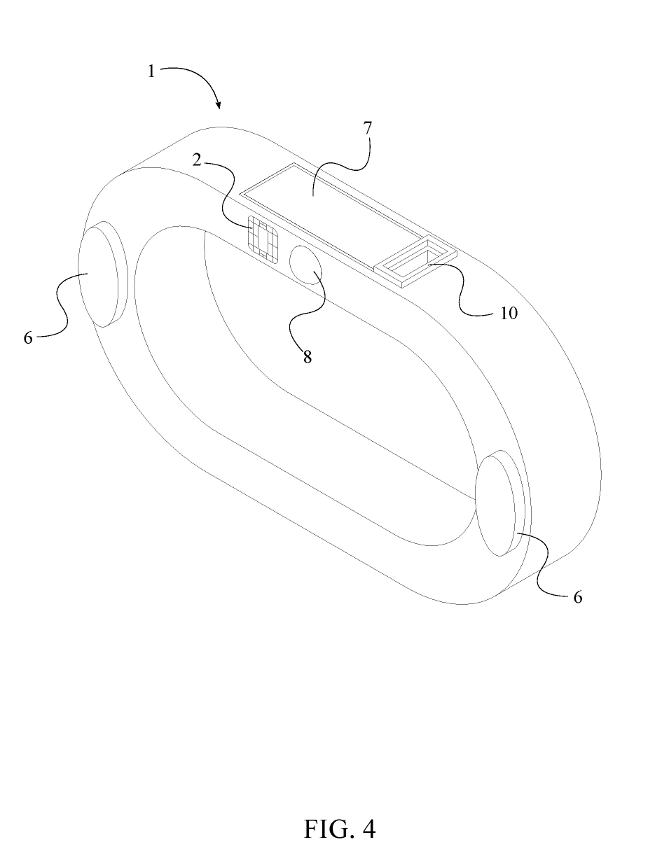

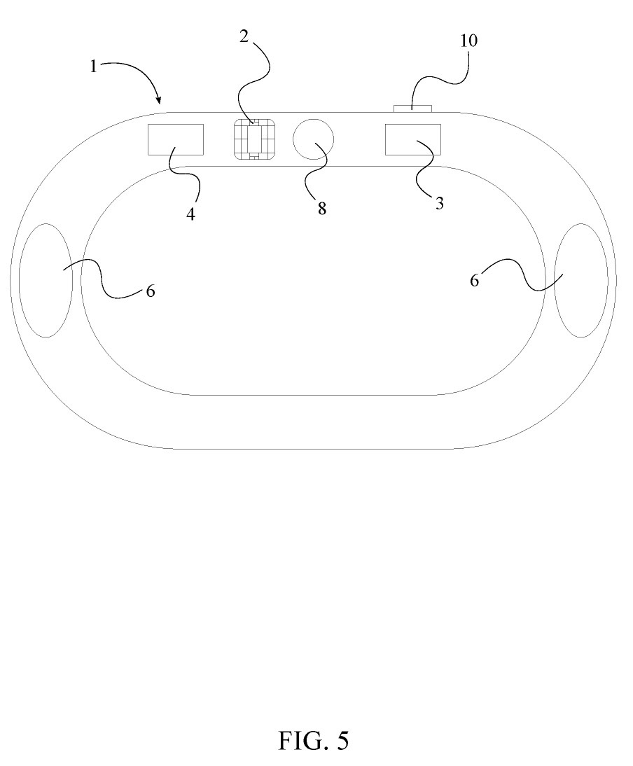

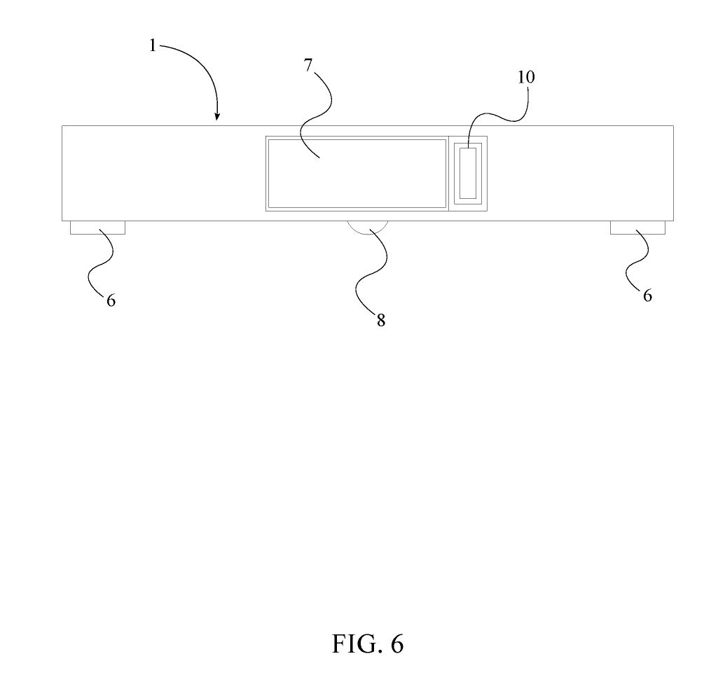

As seen in FIGS. 1-6, the present invention comprises an enclosure 1, a microprocessor 2, a power source 3, a global positioning system (GPS) module 4, a wireless communication device 5, a push button 6, and a storage device 7. The enclosure 1 is used to house the components of the present invention so that the present invention can be used as a single unit. To do so, the power source 3, the storage device 7, the GPS module 4, the wireless communication device 5, and the microprocessor 2 are positioned within the enclosure 1. The power source 3 provides the necessary electric power by being electrically connected to the microprocessor 2, the GPS module 4, the wireless communication device 5, the push button 6, and the storage device 7. For the present invention to transmit and receive processed data, the storage device 7, the GPS module 4, the wireless communication device 5, the push button 6, and the microprocessor 2 are electronically connected to each other. The push button 6, which is used to activate the present invention, is externally mounted onto the enclosure 1. As seen in FIGS. 4-6, the positioning of the push button 6 allows the user to press the push button 6 promptly. The present invention can be used for purposes that can be, but it not limited to, providing location data and storing identification data.

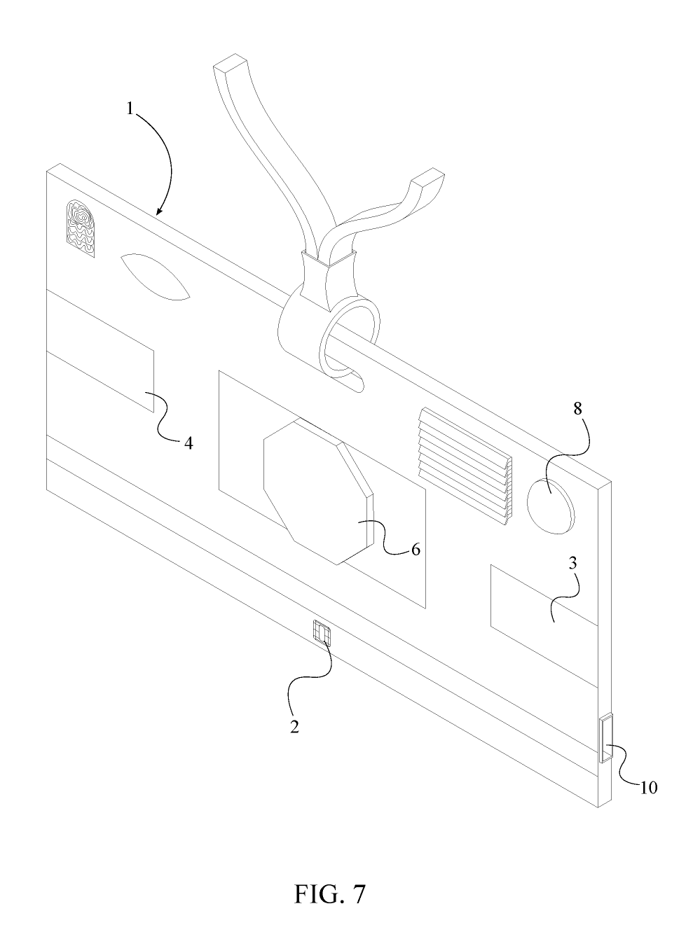

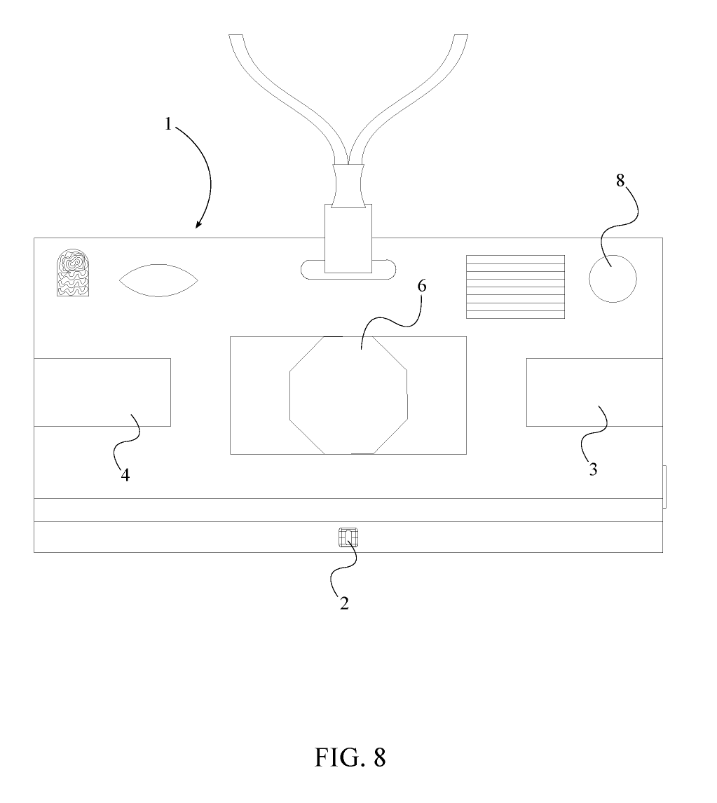

As mentioned, the enclosure 1 allows the user to wear the present invention and to utilize the present invention as a single assembly. As shown in FIGS. 7-9, the size and shape of the enclosure 1 can vary in different embodiments of the present invention. As an example, in one embodiment of the present invention the enclosure 1 can be a necklace pendant so that the present invention can be worn around the neck. In another embodiment of the present invention, the enclosure 1 can be available in the form of a bracelet so that the user can wear the present invention on the wrist. Preferably, the enclosure 1 is a waterproof casing so that the present invention can be used in different environmental conditions. Even though the present invention is intended to be worn, the enclosure 1 also allows the present invention to be utilized as a handheld device.

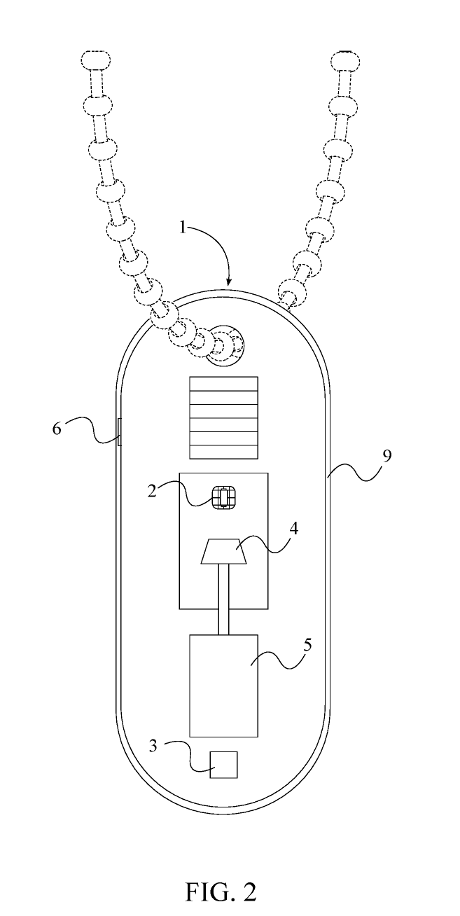

Since the present invention is in contact with the body of the user, it is important to ensure that no bodily harm is caused by any of the components of the present invention. As an example, the possibility of a potential electric discharge from the present invention needs to be eliminated. To do so, the present invention further comprises an insulation layer 9 as illustrated in FIG. 2. The insulation layer 9 surrounds the enclosure 1 such that the enclosure 1 is sleeved by the insulation layer 9 and prevents any electric discharge from contacting the body of the user.

The power source 3 supplies the power needed to operate the present invention. As mentioned before, the power source 3 is electrically connected to the storage device 7, the GPS module 4, the wireless communication device 5, the push button 6, and the microprocessor 2. Preferably, the power source 3 is a rechargeable battery which is removably positioned within the enclosure 1. However, the power source 3 can also be permanently fixed within the enclosure 1.

The present invention further comprises an input/output port 10. In the preferred embodiment of the present invention, the input/output port 10 is a Universal Serial Bus (USB) port that is electronically connected to the power source 3, the storage device 7, and the microprocessor 2. The input/output port 10 traverses into the enclosure 1. The positioning of the input/output port 10 allows the user to conveniently connect a USB cable. By doing so, the user can either charge the power source 3, update functionalities of the microprocessor 2, save data on the storage device 7 or retrieve data from the storage device 7.

The push button 6 determines when the user intends to activate the present invention. As an example, if the user intends on transmitting location data during an emergency, the user applies pressure on the push button 6. Preferably, the push button 6 is designed to be pushed and held for a specific time so that accidental pressing of the push button 6 is avoided. When pressure is applied on the push button 6, the GPS module 4 that is electronically connected to the push button 6 begins the process of gathering location coordinates of the user. In another instance, when the present invention is being used as an identification card, the wireless communication device 5 begins to transmit identification data.

The microprocessor 2 controls data that is being operated within the present invention. The data that is processed by the microprocessor 2 varies from one embodiment to another. As an example, if the location data of the user needs to be transmitted, the microprocessor 2 performs circuit functionalities for the location data of the user. In particular, the location data received from the GPS module 4 is processed by the microprocessor 2. In another instance, if the present invention is used to control identification data, the microprocessor 2 executes the necessary circuit functionalities for identification data.

The present invention receives or transmits data through the wireless communication device 5. In the preferred embodiment of the present invention, the wireless communication device 5 is a radio frequency (RF) transceiver module. However, in other embodiments of the present invention the wireless communication device 5 can also communicate via wireless methods that can be, but is not limited to, Bluetooth or Wi-Fi. The data that is received or transferred through the wireless communication device 5 can vary in different embodiments of the present invention. As an example, if the present invention is used to transmit location data, the wireless communication device 5 transmits location coordinates that were obtained through the GPS module 4. In another instance, if identification data needs to be transmitted, the wireless communication device 5 transfers identification data that is stored on the storage device 7.

The storage device 7 is used to save any user related information. If the present invention is being used to store identification data, the data inputted by the user is saved on the storage device 7. Finger print data, retina identification data, information regarding medical conditions, and other comparable data can be saved on the storage device 7. The storage device 7 is directly connected to the microprocessor 2 so that data in the storage device 7 can be used to perform different functionalities of the present invention. If the present invention is used to contact emergency responders during an emergency, the wireless communication device 5 retrieves necessary contact information from the storage device 7 to contact the emergency responders.

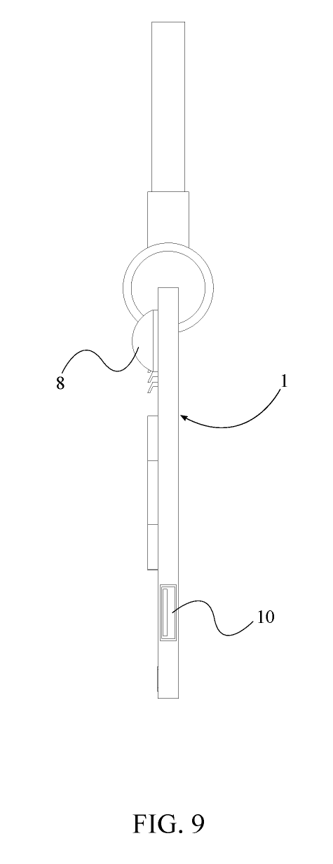

As seen in FIG. 9, the present invention further comprises a light source 8 which is mounted onto the enclosure 1. The light source 8 is intended to be used as a visual alert during an emergency. The light source 8 is electronically connected to the power source 3 and the push button 6 so that the light source 8 is illuminated as the push button 6 is activated. However, the light source 8 can also be activated with a separate light switch so that the light source 8 is not illuminated when the push button 6 is pressed. As an example, emergency responders can use the visual alert to conveniently locate the user during an emergency. The light source 8 can be, but is not limited to, a plurality of light emitting diodes (LEDs). A vibrating mechanism can also be included so that the present invention vibrates while the light source 8 is illuminated. However, the vibrating mechanism can also be designed to function independently.

In a different embodiment, the present invention can comprise different sensors such as an oxygen sensor, biohazard sensor, and/or a carbon monoxide sensor. These sensors, which are especially beneficial in a laboratory environment, will be electronically connected to the power source 3, the microprocessor 2, and the storage device 7. Thus, when a sensor is triggered by an irregularity in the environment, the microprocessor 2 is notified by the sensor so that an emergency alert can be transmitted. As discussed earlier, the emergency alert will be transferred through the wireless communication device 5.

The present invention can also be equipped with a high-voltage circuit in a different embodiment of the present invention. When available, the high-voltage circuit will be electronically connected to the storage device 7 and the microprocessor 2. If the need arises, the high-voltage circuit is triggered so that information saved on the storage device 7 and the microprocessor 2 are erased. Identity theft and the loss of other sensitive information can be eliminated with the use of the high-voltage circuit. The high-voltage circuit is especially beneficial if the present invention is being used in a military environment where securing sensitive information is a high priority. Moreover, when used in military environments, the present invention can be used as an identification tag as shown in FIG. 1 and FIG. 2.

The microprocessor 2 can be programmed so that a first user of the present invention can wirelessly communicate with a second user utilizing the present invention. In doing so, the wireless communication device 5 of the first user will wirelessly intercommunicate with the wireless communication device 5 of the second user. As an example, the intercommunication between the first user and the second user can be executed so that the second user is alerted via the vibrating mechanism when the emergency alert is received. The process of intercommunication can be extended to multiple wireless communication devices by synchronizing each of the multiple wireless communication devices. Radio frequency signals, Bluetooth, or other comparable wireless data transfer method can be used to communicate with each of the wireless communication devices. The ability to synchronize is especially beneficial in military environments and other comparable environments where a plurality of users need to be notified simultaneously.

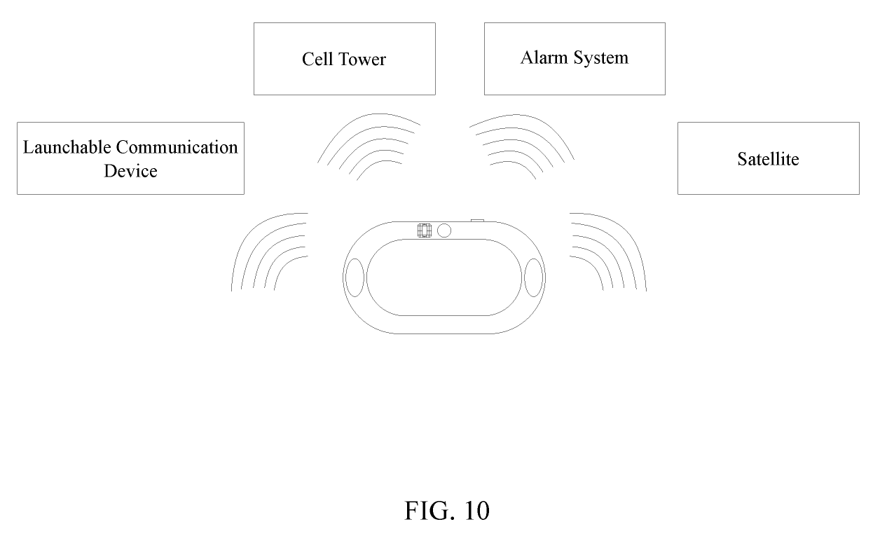

In addition to communicating with other users utilizing the present invention, the wireless communication device 5 can also communicate with existing alarm systems, cell towers, launchable communication devices, and satellites. As illustrated in FIG. 10, the wireless communication device 5 can transmit the emergency alert to a launchable communication device which can be, but is not limited to, a drone. When the present invention transmits the emergency alert, the drone that is synchronized with the wireless communication device 5 is launched to the exact location of the user by utilizing the location coordinates embedded in the emergency alert.

When utilizing the present invention, the following process flow is generally followed. Initially, the present invention is worn by the user. Depending on user preference, the present invention can be worn around the neck or on the wrist. The insulation layer 9 not only protects the user from any potential electric discharge but also provides a comfortable wearing experience. The wearable design allows the user to utilize the present invention regardless of the activity or location. If the user encounters an emergency and needs to contact an emergency responder with a current location, the user applies pressure on the push button 6. The push button 6 activates the GPS module 4, which proceeds to gather the current location coordinates. The current location coordinates are then transferred to the wireless communication device 5 via the microprocessor 2. To notify the emergency responders, the wireless communication device 5 transmits an emergency alert with the current location coordinates. Simultaneously, the light source 8 will also illuminate so that the emergency responders can locate the user conveniently.

In another instance, when the present invention is being used as an identification card, the user data is initially transferred onto the storage device 7 via the input/output port 10. When required, user data is transmitted from the wireless communication device 5. In another embodiment, the present invention can comprise a scanning strip which can be scanned to output user data that is being stored on the storage device 7.

When the power source 3 needs to be recharged or the microprocessor 2 needs to be updated, the input/output port 10 is utilized. The power source 3 is charged by connecting a USB cable to the input/output port 10. Similarly, the microprocessor 2 is also updated by connecting a USB cable to the input/output port 10.

Although the invention has been explained in relation to its preferred embodiment, it is to be understood that many other possible modifications and variations can be made without departing from the spirit and scope of the invention as hereinafter claimed.

What is claimed is:

1. A wearable device for providing personal security comprises:
an enclosure;
a microprocessor;
a power source;
a global positioning system (GPS) module;
a wireless communication device;
a push button;
a storage device;
the power source being electrically connected to the microprocessor, the GPS module, the wireless communication device, the push button, and the storage device;
the storage device, the GPS module, the wireless communication device, the push button, and the microprocessor being electronically connected to each other;
the power source, the storage device, the GPS module, the wireless communication device, and the microprocessor being positioned within the enclosure;
the push button being electronically connected to the wireless communication device and the microprocessor; and
the push button being externally mounted onto the enclosure.

2. The wearable device for providing personal security as claimed in claim 1 comprises:
a light source;
the light source being externally mounted onto the enclosure; and
the light source being electronically connected to the power source and push button.

3. The wearable device for providing personal security as claimed in claim 1 comprises:
an insulation layer; and
the enclosure being sleeved by the insulation layer.

4. The wearable device for providing personal security as claimed in claim 1 comprises:
an input/output port;
the input/output port being electronically connected to the power source, the storage device, and the microprocessor; and
the input/output port traversing into the enclosure.

5. The wearable device for providing personal security as claimed in claim 2, wherein the light source is a plurality of light emitting diodes (LEDs).

6. The wearable device for providing personal security as claimed in claim 1, wherein the enclosure is a waterproof casing.

7. The wearable device for providing personal security as claimed in claim 1, wherein the enclosure is a necklace pendant.

8. The wearable device for providing personal security as claimed in claim 1, wherein the enclosure is a bracelet.

9. The wearable device for providing personal security as claimed in claim 1, wherein the wireless communication device is a radio frequency (RF) transceiver module.
